(19) United States
(12) Patent Application Publication
(10) Pub. No.: US 2019/0251803 A1
(43) Pub. Date: Aug. 15, 2019

(54) RINGER CONTROL DEVICE AND RINGER CONTROL METHOD

(71) Applicant: Goldtek Technology Co., Ltd., New Taipei City (TW)

(72) Inventor: TING-HSUAN SU, New Taipei City (TW)

(21) Appl. No.: 16/258,709

(22) Filed: Jan. 28, 2019

(30) Foreign Application Priority Data
Feb. 9, 2018 (TW) 107104844

(51) Int. Cl. G08B 3/10

(52) U.S. Cl. CPC G08B 3/10

(57) ABSTRACT

A ringer control device comprises a power receiving unit, a detection circuit, and a control circuit. The detection circuit is coupled to the power receiving unit, configured to generate a detection signal based on presence of a ringer device connected to the power receiving unit. The control circuit is coupled to the detection circuit and comprises a trigger unit, a control unit, and a switching unit. The trigger unit generates a trigger signal upon detection of a trigger event. The control unit is coupled to the detection circuit and configured to generate a switching signal based on the trigger signal and the detection signal. The switching unit is coupled to the control unit. If the detection signal indicates presence of a ringer device coupled to the power receiving unit, the switching signal switches on the switching unit so as to activate the ringer device.

### CROSS-REFERENCE TO RELATED APPLICATIONS

This application claims priority to Taiwanese Invention Patent Application No. 107104844 filed on Feb. 9, 2018, the contents of which are incorporated by reference herein.

### FIELD

The instant disclosure relates to a ringer control device and a control method thereof, and particularly a door bell control device and a control method thereof.

### BACKGROUND

A conventional electronic doorbell device can be connected to an external power source and a mechanical doorbell device through a Pogo Pin connector. However, if the electronic doorbell device is directly connected to an external power source without serially connecting a mechanical doorbell, the Pogo pin connector of the electronic doorbell device would receive an input current higher than its rated current, potentially causing damage to the spring in the Pogo pin connector. As a result, the electronic doorbell device is subject to premature malfunction.

### SUMMARY

In view of the above, there is a need for a ringer control device and a control method thereof, which can automatically detect whether a mechanical doorbell is coupled with an electronic doorbell device, and to provide adjustment accordingly based on the detection result.

Embodiments of the instant disclosure provides a ringer control device including a power receiving unit, a detection circuit, and a control circuit. The detection circuit is coupled to the power receiving unit and configured to generate a detection signal based on presence of a ringer device in connection with the power receiving unit. The control circuit is coupled to the detection circuit, and the control circuit further includes a trigger unit, a control unit and a switching unit. The trigger unit is configured to generate a trigger signal when detecting a trigger event. The control unit is coupled to the detection circuit and the triggering unit, and is configured to generate a switching signal according to the trigger signal and the detection signal. The switching unit is coupled to the control unit. If the power receiving unit is coupled to a ringer device, the switching signal turns on the switching unit to activate the ringer device. If the power receiving unit is not coupled to the ring device, the switching signal turns off the switching unit.

Embodiments of the instant disclosure also provides a method for controlling bell of a ringer control device having a switching unit. The method comprises receiving, by the ringer control device, a trigger signal that indicates a trigger event. Upon receipt of the trigger signal, generating a switching signal based on a detection signal. The detection signal indicates a detection result of a presence of a ringer device in connection with the ringer control device. The method further comprises: if the detection signal indicates presence of ringer device connected to the power receiving unit, switching on the switching unit based on the switching signal so as to activate the ringer device. On the other hand, if the detection signal indicates no presence of ringer device connected to the power receiving unit, switching off the switching unit based on the switching signal.

Embodiments of the instant disclosure further provides a ringer control device that comprises: a trigger unit, a control unit, and a switching unit. The trigger unit is configured to generate a trigger signal upon detection of a trigger event. The control unit is coupled to the trigger unit, and is configured to selectively generate a first switching signal and a second switching signal. If the ringer control device is in connection with a ringer device, upon receipt of the trigger signal, the control unit generates the first switching signal. If the ringer control device is not in connection with a ringer device, upon receipt of the trigger signal, the control unit generates the second switching signal. The switching unit is coupled to the control unit and configured to receive the switching signals. When the first switching signal is received, the switching unit is turned on to activate the ringer device that is connected to the ringer control device. When the switching unit receives the second switching signal, the switching unit is turned off.

Thus, the ringer control device in accordance with embodiments of the instant disclosure can automatically detect the presence of a ringer device coupled thereto, thereby confirming whether the switching unit can be activated according to the detection result, so as to provide automatic adjustments to avoid potential device damage due to excessive current.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 shows a functional block diagram of a ringer control system in accordance with a first embodiment of the present disclosure.

FIG. 2 shows a functional block diagram of a ringer control system in accordance with a second embodiment of the present disclosure.

FIG. 3 shows a circuit diagram of an exemplary detection circuit for the ringer control system in accordance with one embodiment of the instant disclosure.

FIG. 4 shows a flowchart illustrating a method for controlling a ringer control device in a ringer system in accordance with the first embodiment of the instant disclosure.

FIG. 5 shows a flowchart illustrating a method for controlling a ringer control device in a ringer system in accordance with the second embodiment of the instant disclosure.

### DETAILED DESCRIPTION

Embodiments of the instant disclosure will be specifically described below with reference to the accompanying drawings.

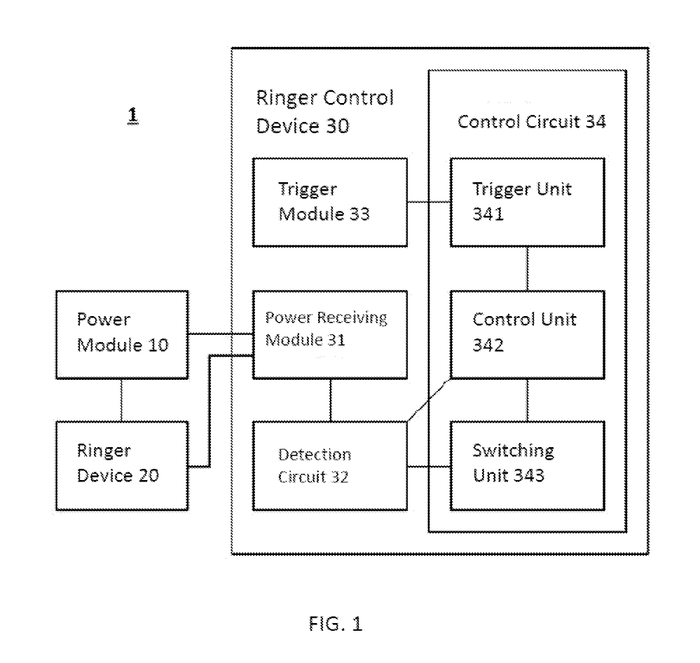

Please refer to FIG. 1, which shows a functional block diagram of an exemplary ringer system 1 in accordance with a first embodiment of the present disclosure. The ringer system 1 includes a power module 10, a ringer device 20, and a ringer control device 30. The ringer control device 30 includes a power receiving unit 31, a detection circuit 32, a trigger module 33, and a control circuit 34. The control circuit 34 further includes a trigger unit 341, a control unit 342, and a switching unit 343.

In one exemplary embodiment, the ringer system 1 can be a door bell system applied to an access passage, which may be utilized to announce the presence of a person (or creature) in proximity thereto, and accordingly activate the ringer device 20 in order to notify the occupants on the other side of the door. In addition, the triggering of the door bell system can be used to send notification to an electronic device (e.g., a portable device, not shown) that has established a connection therewith in advance to inform an owner thereof that a person or a living being's presence proximate the access passage.

In one exemplary embodiment, the power module 10 can be a transformer device. In one exemplary embodiment, the transformer device can be coupled to an AC power source (not shown) to meet the operational power requirements for the ringer device 20 and the ringer control device 30. In one exemplary embodiment, the power module 10 can be any form of power output device capable of stably providing the required power for the ringer device 20 and the ringer control device 30.

In one exemplary embodiment, the ringer device 20 can be a mechanical bell or an electronic bell. A mechanical bell generates a ringtone through mechanical collision, whereas an electronic bell produces a ringtone through broadcasting a pre-recorded music or sound. In one exemplary embodiment, the ringer device 20 can be coupled to the power module 10 to obtain the required power therefrom. In addition, the ringer device 20 can be coupled to the ringer control device 30, such that the ringer control device 30 may determine whether the ringer device 20 should be activated to generate ringtone.

In one exemplary embodiment, the power receiving unit 31 of the ringer control device 30 can be a contact power pin, such as a Pogo pin. The ringer control device 30 can obtain the power output from the power module 10 through the power receiving unit 31.

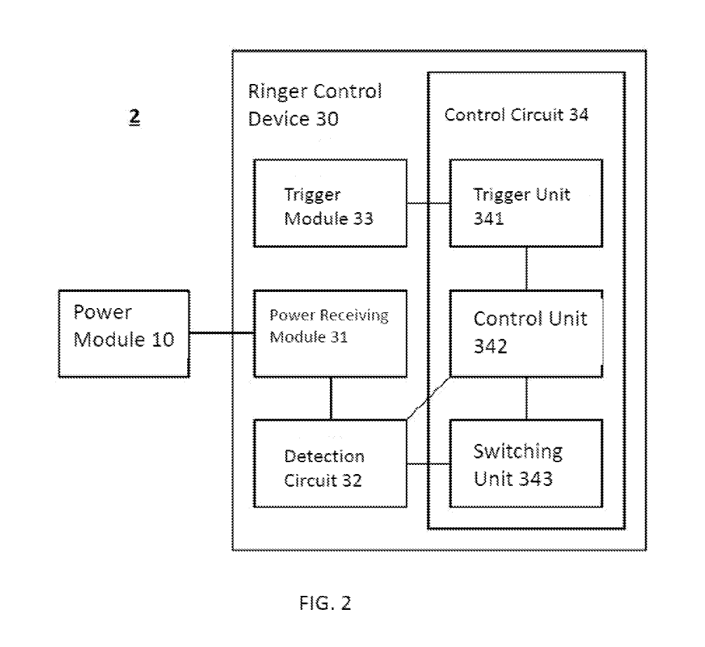

In one exemplary embodiment, the detection circuit 32 of the ringer control device 30 is configured to detect the presence of the ringer module 20 between the ringing control device 30 and the power module 10, and transmit a detection signal accordingly. In one embodiment, referring to FIG. 2, which shows a functional block diagram of a ringer control system in accordance with a second embodiment of the present disclosure, the ringer system 2 includes a power module 10 and a ringer control device 30 directly coupled to the power module 10. In this embodiment, the detection module 32 does not detect the presence of the ringer device 20, and will notify the control unit 342 the absence of a ringer device by generating an associated detection signal.

In one exemplary embodiment, the trigger module 33 can be any type of input device such as a touch panel, a touch screen, or a button operable to receive a triggering action. When an operator presses or touches the trigger module 33, the ringer control device 30 is activated to confirm the occurrence of a triggering event, and accordingly generate a trigger signal. If the ringer system 2 does not have a ringer device (e.g., a ringer device 20) connected thereto, the ringing control device 30 may notify the occurrence of a triggering event through other arrangements, e.g., through a communication module (not shown) and a receiving device (not shown) to communicate the trigger signal (e.g., in a wireless manner). If a ringer device 20 is present (e.g., ringer system 1), the ringing control device 30 may communicate with the abovementioned receiving device through the communication module, as well as generating a ringtone through the ringer device 20 as a trigger notification. In one exemplary embodiment, the trigger module 33 can include an image capturing device, which can be utilized to determine the presence of a person or other creature in the proximity thereof, thus enabling the ringer control device 30 to determine/confirm the occurrence of a triggering event.

In one exemplary embodiment, the control circuit 34 can be implemented on a system motherboard of the ringer control device 30. The trigger unit 341 is coupled to the trigger module 33, and configured to enable the trigger unit 341 to generate a trigger signal when the trigger module 33 is subject to a trigger action (associated with a trigger event), and transmit the trigger signal to the control unit 342, thereby notifying the control unit 342 to issue the trigger notification.

In one exemplary embodiment, the control unit 342 can be a processor or a microcontroller configured to execute program instructions stored in an accessible readable storage medium. In one exemplary embodiment, the control unit 342 is coupled to the detection circuit 32, and configured to obtain a detection result of the detection circuit 32 and store the information therein. In one exemplary embodiment, if the ringer system (e.g., system 1) has a ringer device connected thereto (e.g., ringer 20), the control unit 342 can record a system parameter associated with the detection result of the ringer device 20, for example: MCU[doorbell]=1. In one exemplary embodiment, if the ringer system (e.g., system 2) does not have a ringer device connected thereto, the control unit 342 may record the system parameter: MCU [doorbell]=0. In one exemplary embodiment, the control unit 342 can be coupled to the trigger unit 341, and configured to receive the trigger signal provided by the trigger unit 341. When the control unit 342 receives the trigger signal, the control unit 342 can determine whether to switch on the switching unit 343 based on the stored system parameters.

In one exemplary embodiment, the switching unit 343 can be a Triode for Alternating Current (TRIAC), and the switching unit 343 is coupled to the control unit 342 to receive a switching signal transmitted from the control unit 342.

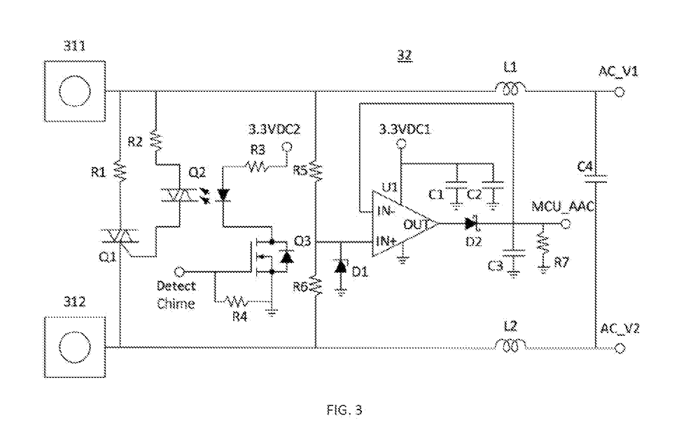

FIG. 3 shows a circuit diagram of an exemplary detection circuit 32 for the ringer control system in accordance with one embodiment of the instant disclosure. The detecting circuit 32 includes a processing circuit U1, a plurality of resistors R1-R7, a plurality of capacitors C1-C4, a plurality of inductors L1-L2, a plurality of diodes D1-D2, a plurality of switching circuits Q1-Q3, and six nodes of the detection circuit 32: Detect Chime, 3.3 VDC1, 3.3 VDC1, MCU_AAC, AC_V1 and AC_V2. It should be noted that, the use and connection of capacitors, inductors, resistors, diodes, switching circuits and processing circuits in the figures are only schematic connections; the circuit connection and electronic component for the detecting circuit 32 should not be limited to that illustrated in the instant figure.

In one exemplary embodiment, the detection circuit 32 is coupled to the power receiving unit 31 to receive an output voltage from the power module 10 (as shown in previous figures). In one exemplary embodiment, the power receiving unit 31 includes a first receiving unit 311 and a second receiving unit 312. The power receiving unit 31 is coupled to the detection circuit 32 through the first receiving unit 311 and the second receiving unit 312. In one exemplary embodiment, the first receiving unit 311 and the second receiving unit 312 can each be a Pogo pin, respectively.

In one exemplary embodiment, the processing circuit U1 includes a comparator. The processing circuit U1 includes a plurality of terminals (e.g., pins IN+, IN− and OUT). In this embodiment, the pin IN+ of the processing circuit U1 receives the voltage supplied from the power module 10, and accordingly determines whether a ringer device (e.g., ringer 20) is coupled to the ringer control device 30. In one exemplary embodiment, when the ringer control device 30 is coupled to the ringer device 20, because the ringer device 20 presents a load, given that the voltage range provided by the power module 10 is fixed, the received first voltage at pin IN+ of the processing circuit U1 is relatively low. In contrast, when the ringer control device 30 is not coupled to a ringer device, due to the absence of the load of the ringing device, a second voltage received by pin IN+ of the processing circuit U1 will be larger relative to the first voltage. Accordingly, it is possible to determine whether a ringer device (e.g., ringer 20) is in connection with the ringer control device 30.

In one exemplary embodiment, pin OUT of the processing circuit U1 is coupled to node MCU_ACC of the detection circuit 32, and node MCU_ACC is coupled to the control unit 342. The control unit 342 can determine the presence of a ringer device (e.g., ringer 20) in connection with the ringer control device 30 based on the voltage from the processing unit U1. In one exemplary embodiment, if the ringer system has a ringer device connected thereto (e.g., system 1 with ringer 20), the control unit 342 records a system parameter: MCU [doorbell]=1. In one exemplary embodiment, when the ringer system does not have a ringer device coupled thereto (e.g., system 2), the control unit 342 records a system parameter: MCU [doorbell]=0.

In one exemplary embodiment, node AC_V1 and node AC_V2 of the detection circuit 32 can be coupled to the switching unit 343. Accordingly, upon receiving the trigger signal, if the control unit 342 confirms the presence of a ringer device (e.g., ringer 20) based on the recorded system parameter associated with the detection signal, the control unit 342 enables the switching unit 343, thereby forming a closed loop from node AC_V1 to node AC_V2 through the switching unit 343. Accordingly, the ringer device 20 is turned on to generate a ringtone notification. Conversely, when the control unit 342 receives the trigger signal, if the control unit 342 determines that the system parameter associated with the detection signal indicates the absence of a ringer device, the control unit 342 would disconnect the switching unit 343. Thus, node AC_V1 and node AC_V2 cannot form a closed loop through the switching unit 343. Accordingly, the first receiving unit 311 and the second receiving unit 312 would not receive excessive current that would cause potential damage to the internal components of the power receiving unit 31.

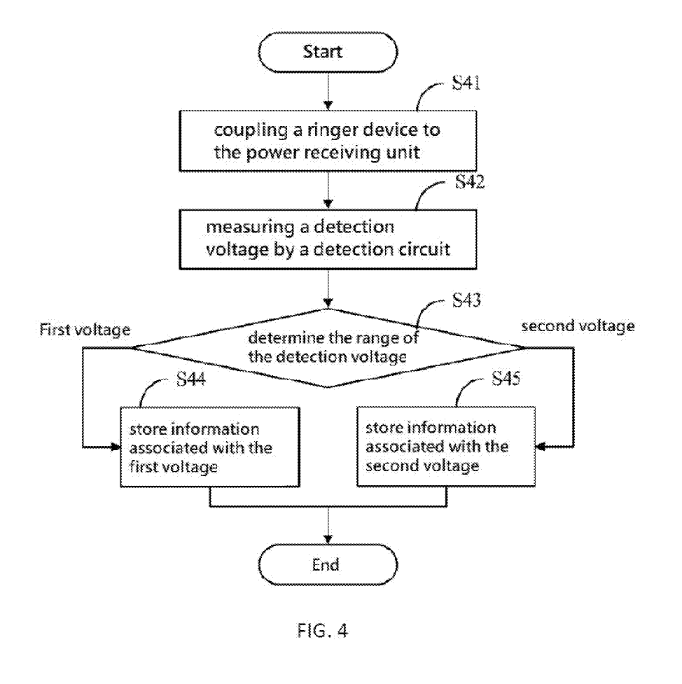

FIG. 4 shows a flowchart illustrating a method for controlling a ringer control device in a ringer system in accordance with the first embodiment of the instant disclosure. It should be noted that, based on actual implementation requirements, the order/sequence of the processes can be changed or omitted. Likewise, additional process may be added/inserted without departing from the scope of the instant disclosure.

In process S41, a ringer control device 30 is coupled to a power module 10.

In one exemplary embodiment, the ringer control device 30 includes a power receiving unit 31. The ringer control device 30 is coupled to the power module 10 through the power receiving unit 31. In one exemplary embodiment, the power receiving unit 31 includes a first receiving unit 311 and a second receiving unit 312. The power receiving unit 31, which is configured to couple an external alternating current (AC) power source (not shown), further includes a first output unit and a second output unit (now shown). The first receiving unit 311 is coupled to the first output unit, while the second receiving unit 312 is coupled to the second output unit, so as to receive an input voltage from the external AC power source through the power module 10.

In process S42, a detection voltage is measured through a detection circuit 32 of the ringer control device 30.

In one exemplary embodiment, the detection circuit 32 determines whether a ringer device (e.g., ringer 20) is present (e.g., connected) between the ringer control device 30 and the power module 10.

In process S43, the detection circuit 32 can determine the value/range of the detection voltage, e.g., whether the detection voltage is in a first voltage range or a second voltage range. If the detection voltage is in the first voltage range, the method proceeds to process S44. If the detection voltage is in the second voltage range, process S45 will be performed.

In one exemplary embodiment, the detection circuit 32 may determine, through the processing circuit U1, whether the detection voltage is a first voltage or a second voltage (or, within a first voltage range or a second voltage range). In one exemplary embodiment, the first voltage range can be between 2.1 and 2.4V, and the second voltage range can be between 2.5 and 2.7V. When the ringer control device 30 is in connection with a ringer device (e.g., ringer 20), the overall load of the ringer system (e.g., system 1) is relatively high, and thus the detection voltage measured by the detection circuit 32 would be relatively low. When the ringer control device 30 is not in connection with a ringer device, the overall load of the ringer system (e.g., system 2) would be relatively low, thus the detection voltage obtained by the detection circuit 32 would be higher than that of the ringer system 1.

In process S44, the control unit 342 stores the information/result associated with the detection of the first voltage.

In one exemplary embodiment, the control unit 342 may include an internal memory (not shown). In one exemplary embodiment, the control unit 342 may record a system parameter associated with the detection signal from the detection circuit 32 through the internal memory or other storage medium located in the ringer control device 30. For example, when the detection result falls in the first voltage range and the ringer control device 30 is coupled to a ringer device 20, the control unit 342 may record a system parameter “MCU [doorbell]=1.”

In process S45, the control unit 342 stores the information/result associated with the detection of the second voltage.

In one exemplary embodiment, the control unit 342 may record the system parameters associated with the detection signal through the internal memory or other storage medium located in the ringer control device 30. For example, when the detection voltage belongs to the second voltage range and the ringer control device 30 is not in connection with a ringing device, the control unit 342 may record the system parameter “MCU [doorbell]=0” as indication.

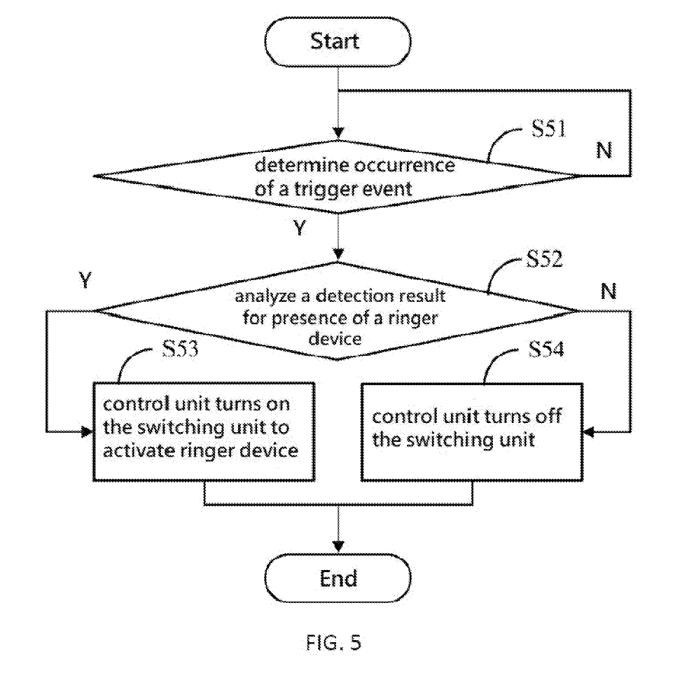

Please refer to FIG. 5, which shows a flowchart illustrating a method for controlling a ringer control device in a ringer system in accordance with the second embodiment of the instant disclosure. It should be noted that, based on actual implementation requirements, the order/sequence of the processes can be changed or omitted. Likewise, additional process may be added/inserted without departing from the scope of the instant disclosure.

In process S51, a trigger unit 341 of a control circuit 34 of the ringer control device 30 determines whether a trigger event has occurred. If the trigger unit 341 determines that the trigger event has occurred, process S52 may be performed. Conversely, if the trigger unit 341 determines that a trigger event has not occurred, the method remains at process S51.

In one exemplary embodiment, when a user presses or touches the trigger module 33, the trigger unit 341 confirms that a trigger event occurs and in response issues a trigger signal. In one exemplary embodiment, the trigger module 33 may also include an image capturing device. The image capturing device may determine whether a person or other creature is in the proximity (e.g., of the door way where the ringer is installed), so that the trigger unit 341 may more accurately confirm the occurrence of a trigger event.

In process S52, the control unit 342 of the control circuit 34 determines whether the ringer control device 30 is coupled to a ring device according to a stored detection result. If the ringer control device 30 is coupled to a ringer device (e.g., ringer 20), the method proceeds to process S53. If the ringer control device 30 is not coupled to a ringer device, process S54 is performed instead.

In one exemplary embodiment, the control unit 342 may access an internal memory (or another storage medium located in the ringer control device 30) for the stored system parameter associated with a detection result, so as to determine the presence of a ringer device (e.g., ringer 20) in connection therewith. For example, the control unit 342 may indicate the absence of a ringer device connected thereto by the stored record “MCU[doorbell]=0. Conversely, the control unit 342 may indicate the presence of a ringer device (e.g., ringer 20) connected to the ringer control device 30 through the stored record of “MUC[doorbell]=1.”

In process S53, the control unit 342 may turn on the switching unit 343 of the switching circuit 34, thereby activating the ringer device 20.

In one exemplary embodiment, the control unit 342 may transmit a first switching signal to turn on the switching unit 343, so as form a closed loop to the power receiving unit 31 of the ringer control unit 30 connected thereto. Accordingly, a power conduction path is provided to the ringer device 20, thereby enabling the generation of a ringtone notification.

In process S54, the control unit 342 may turn of the switching unit 343 of the control circuit 34.

In one exemplary embodiment, the control unit 342 may transmit a second switching signal to turn off the switching unit 343, so that disconnect the power receiving unit 31 connected thereto from the power source, so as to prevent the power receiving unit 31 from receiving excessive current that may cause potential damage to the internal components thereof.

It should be noted that, the circuit components or the operation modes of the exemplary ringer control device described in the foregoing embodiments may be interchanged or combined, given no substantial conflicts in compatibility. Thus, the scope of disclosure should not be limited to the specific embodiments described herein.

The embodiments shown and described above are only examples. Many details are often found in this field of art thus many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A ringer control device, comprising:
a power receiving unit;
a detection circuit coupled to the power receiving unit, configured to generate a detection signal based on presence of a ringer device in connection with the power receiving unit;
a control circuit coupled to the detection circuit and comprising:
a trigger unit configured to generate a trigger signal upon detection of a trigger event;
a control unit coupled to the detection circuit, configured to generate a switching signal based on the trigger signal and the detection signal; and
a switching unit coupled to the control unit, wherein
if the detection signal indicates presence of a ringer device in connection with the power receiving unit, the switching signal switches on the switching unit so as to activate the ringer device;
if the detection signal indicates no presence of a ringer device in connection with the power receiving unit, the switching signal turns off the switching unit.

2. The ringer control device of claim 1, wherein the control unit is further configured to store information associated with the detection signal, and upon receipt of the trigger signal, generate the switching signal based on the detection signal.

3. The ringer control device of claim 1, wherein the detection circuit is configured to generate the detection signal based on obtaining a detected voltage through performing detection.

4. The ringer control device of claim 3, wherein the detected voltage is associated with a first voltage range when the power receiving unit is in connection with the ringer device; wherein the detected voltage is associated with a second voltage range that is greater than the first voltage range when the power receiving unit is not in connection with the ringer device.

5. The ringer control device of claim 1, further comprising a trigger module coupled to the trigger unit configured to receive a triggering action associated with the trigger event.

6. A method for controlling bell of a ringer control device having a switching unit, comprising:
receiving, by the ringer control device, a trigger signal that indicates a trigger event;
upon receipt of the trigger signal, generating a switching signal based on a detection signal, wherein the detection signal indicates a presence of a ringer device in connection with the ringer control device; and
if the detection signal indicates presence of ringer device connected to the power receiving unit, switching on the switching unit based on the switching signal so as to activate the ringer device;
if the detection signal indicates no presence of ringer device connected to the power receiving unit, switching off the switching unit based on the switching signal.

7. The method of claim 6, wherein the ringer control device comprises a control unit configured to store information associated with the detection signal, and generate the switching signal based on the detection signal upon receipt of the trigger signal by the ringer control device.

8. The method of claim 6, wherein the ringer control device comprises a detection circuit configured to obtain a detection voltage, and generate the detection signal based on the detection voltage.

9. The method of claim 8, wherein the detected voltage is associated with a first voltage range when the power receiving unit is in connection with the ringer device; wherein the detected voltage is associated with a second voltage range that is greater than the first voltage range when the power receiving unit is not in connection with the ringer device.

10. A ringer control device, comprising:
a trigger unit configured to generate a trigger signal upon detection of a trigger event;
a control unit coupled to the trigger unit, configured to selectively generate:
a first switching signal upon receipt of the trigger signal if the ringer control device is in connection with a ringer device, and
a second switching signal upon receipt of the trigger signal if the ringer control device is not in connection with a ringer device; and
a switching unit coupled to the control unit, configured to receive the switching signals and be
switched on to activate the ringer device when receiving the first switching signal, and
switched off when receiving the second switching signal.
